(19) United States
(12) Patent Application Publication
(10) Pub. No.: US 2025/0196155 A1
(43) Pub. Date: Jun. 19, 2025

(54) COMMINUTING MACHINE FOR COMMINUTING A PRODUCT WHILE FEEDING A FLUID

(71) Applicants: Karl Schnell GmbH & Co. KG, Winterbach (DE); Linde GmbH, Pullach (DE)

(72) Inventors: Eugen Jöchner, Creglingen (DE); Norbert Herz, Burgoberbach (DE); Ernst-Otto Schnell, Winterbach (DE); Rudolf Berghoff, Pullach (DE)

(21) Appl. No.: 19/072,151

(22) Filed: Mar. 6, 2025

Related U.S. Application Data
(63) Continuation of application No. PCT/EP2023/073136, filed on Aug. 23, 2023.

(30) Foreign Application Priority Data
Sep. 7, 2022 (DE) 10 2022 122 710.3

(51) Int. Cl. B02C 23/18; B02C 18/14; B02C 18/16

(52) U.S. Cl. CPC B02C 23/18; B02C 18/146; B02C 18/16; B02C 2018/147; B02C 2018/162

(57) ABSTRACT

A comminuting machine for comminuting a product includes: a cutting device for comminuting the product, which device has at least two cutting units; a drive shaft for driving the cutting units; and a housing in which the cutting units are arranged one behind the other along the longitudinal axis of the drive shaft. The comminuting machine is designed to feed a fluid in the form of a liquid gas into at least one intermediate space which is formed in the housing between two cutting units that are adjacent to one another along the longitudinal axis of the drive shaft.

### CROSS REFERENCE TO RELATED APPLICATIONS

This continuation application claims priority to PCT/EP2023/073136 filed on Aug. 23, 2023 which has published as WO 2024/052124 A1 and also the German application number DE 10 2022 122 710.3 filed Sep. 7, 2022, the entire contents of which are fully incorporated herein with these references.

### DESCRIPTION

### Field of the Invention

The present invention relates to a comminuting machine for comminuting a product, comprising: a cutting device for comminuting the product, which has at least two cutting sets, a drive shaft for driving the cutting sets, and a housing in which the cutting sets are arranged one behind the other along a longitudinal axis of the drive shaft. The invention also relates to a method for comminuting a product in a comminuting machine, in particular, in a comminuting machine which is designed as described further above, comprising: comminuting the product in a cutting device of the comminuting machine, the cutting device having at least two cutting sets which are arranged one behind the other in a housing, along a longitudinal axis of a drive shaft, and which are driven by the drive shaft.

### Background of the Invention

The product that is comminuted in the comminuting machine can in principle be any product to be comminuted. For example, the product to be comminuted may be a food product, animal feed, cosmetic products, e.g., for collagen production, or a product from the chemical industry. The product heats up during comminuting due to the input of mechanical drive energy. There is therefore usually a need for temperature control, typically for cooling, of the product. This applies, in particular, when comminuting bones or other comparatively hard products that cause considerable heating during comminution.

In the case of comminuting machines the interior of which is accessible to an operator (“open systems”), for example what are known as cutters, the starting product can be cooled before comminution by the direct addition of a cooling medium. In this case, water, ice or dry ice, for example, can be added to the starting product, located in a bowl, as a cooling medium, if the protective hood of the cutter is closed before or during the comminution of the starting product. Liquid gas, e.g., liquid nitrogen or liquid carbon dioxide CO₂, can also be used to cool the product in the case of a cutter (see for example “https://www.seydelmann.com/wp-content/uploads/2015/05/150529-_-Datenblatt-Vakuum-Koch-K-754-DE.pdf”).

In the case of comminuting machines the interior of which is not accessible to an operator, the starting product can also be cooled by adding a cooling medium, e.g., in the form of water or dry ice, before the starting product is fed into the comminuting machine.

RU 2614828 C1 describes a comminuting machine that has a cooling chamber in which the starting product is cooled before being fed to a comminutor. A tangential branch pipe leads into the cooling chamber, via which pipe a cooling medium, e.g., CO₂, is fed, in order to increase the ductility of the starting product before comminution.

A method for cooling products, in particular, foodstuffs, by means of two cryogenic liquids, nitrogen and carbon dioxide CO₂, in a cooling device, which is an enclosure from the group comprising mixers, kneaders or mills, is known from EP 2 509 428 B1. The cryogenic liquids are injected into a mass of the product to be cooled, in the lower part of the enclosure. A forced injection system can be arranged in the upper region of the enclosure, which enables the cooling capacity of the cold gases resulting from the lower injection of the cryogenic liquids to be returned and used.

DE 20 2016 106601 U1 describes an ultrafine comminutor which has a cutting system for comminuting food, chemical and/or medical products, a drive shaft for driving the cutting system, and a housing in which the cutting system is arranged, which has at least one cutting set. The housing comprises a temperature control channel which is designed to control the temperature of the housing directly and of food products in the housing indirectly, with the aid of a temperature control agent. The temperature control channel can have multiple interconnected temperature control holes.

### SUMMARY OF THE INVENTION

### Object of the Invention

The object of the present invention is that of further developing a comminuting machine and a method for comminuting a product, in order to increase the quality of the product obtained during comminution.

### Subject Matter of the Invention

This object is achieved by a comminuting machine of the type mentioned at the outset, which is designed to feed a fluid, in particular, a liquid gas, into at least one intermediate space which is formed in the housing between two cutting sets which are adjacent in the longitudinal direction or along the longitudinal axis of the drive shaft.

In the comminuting machine according to the invention, a fluid, i.e., a liquid or a gas, is sprayed directly into the product between two adjacent cutting sets or cutting stages and distributed at high speed in a way that is gentle on the product. When using a fluid in the form of a liquid gas for cooling, it is possible to cool directly at the point where the heat is generated (the liquid gas “evaporates” abruptly) and, conversely, also to minimize/eliminate the “harmful” effect (“cold/freezer burn”) of the cooling medium. In this way, ‘cold spots,’ which often occur in other injection processes, are prevented, and optimum heat transfer and optimum temperature distribution are guaranteed.

It has been found that the feed of a liquid or a gas is also possible in a closed system, i.e., between two axially adjacent cutting sets, i.e., adjacent along the longitudinal axis of the drive shaft, without critical pressures occurring in the process that lead to a deterioration in the quality of the product or to damage to the comminuting machine. This also applies in the event that the drive shaft, which is driven by a motor, rotates at high speeds of more than 3000 rpm, for example.

The fluid can be used, for example, to inertize, i.e., to increase the shelf life, by displacing atmospheric oxygen and/or to control the temperature of, for example to cool, the product. In particular, a liquid gas, e.g., liquid N₂ or CO₂, can be supplied to the intermediate space or the product located in the intermediate space for cooling. In this case, the product is cooled directly at the point where heat is generated by the comminution of the product using a respective cutting set. Cooling is therefore particularly efficient; in addition, only a small proportion of the energy used for cooling is released into the environment.

Feeding gases or liquid gases to the product also has the advantage that they can be removed from the product with virtually no residue when the product leaves the comminuting machine, whereas this is not the case when liquids are added. The degassing of the product (“deareation”) can be carried out with the aid of a degassing system. An effective degassing or extraction system (degasser or deaerator) can, for example, be designed in the form of a hollow cylinder similar to a cyclone. A large surface area can be created on the inlet side of such an extraction system by means of a “baffle plate”. In this way, the “drop height” in the cylinder can be used for degassing. Depending on the properties of the product, the gas can also remain bound in the product, e.g., to “foam up” the product and to improve the conveying behavior of the cutting device in certain comminuting processes or products to be comminuted. The addition of a gaseous medium can be advantageous, for example, if the product tends to stick together or form lumps, as is the case for example with certain products in the chemical industry.

In the event that the comminuting machine has more than two cutting sets, the fluid can be fed to each of the intermediate spaces. However, it is also possible for the fluid to be supplied to only one of the intermediate spaces or to two or more intermediate spaces. There are various options for feeding the fluid to a respective intermediate space.

In one embodiment, the comminuting machine has at least one nozzle for discharging the fluid into the intermediate space, which is formed at one end of a feed channel that preferably extends in the housing. The nozzle influences the flow of the fluid as it passes over or exits the feed channel into the intermediate space. The feed channel is usually formed in the housing. In principle, however, it is also possible for the feed channel to be formed on another component of the comminuting machine. For example, the feed channel can extend in or along the drive shaft and possibly in components that are non-rotatably connected to the drive shaft.

In the event that the feed channel extends in the housing, it typically has a first end that opens into the intermediate space at the nozzle, and a second end that opens on the outside of the housing. At the second end, the feed channel is usually connected to a feed line for the fluid. The feed channel is preferably a single, e.g., radial, bore in the housing. It is also possible that a feed channel branches out from the second end on the outside of the housing and has multiple ends at which nozzles are formed that open into the intermediate space. There is a risk of product entering the nozzles and clogging them.

If multiple nozzles are provided, it has proven to be favorable if these are arranged uniformly in the peripheral direction. The nozzle, or more precisely the inside of the nozzle, can have a constant cross-section, but it is also possible for the nozzle cross-section to increase or decrease in the direction of the discharge opening of the nozzle. The inside of the nozzle can be conical, for example.

In a development of this embodiment, the nozzle is designed for the essentially tangential discharge of the fluid in relation to the longitudinal axis of the drive shaft. It has found to be favorable if the fluid flows essentially tangentially into the intermediate space. Essentially tangential means that the nozzle or its longitudinal axis is aligned in an angular range between approx. 50° and approx. 130°, preferably between approx. 70° and approx. 110°, to the radial direction in relation to the longitudinal axis of the drive shaft. The nozzle can be designed or aligned to discharge the fluid in a plane perpendicular to the longitudinal axis of the drive shaft.

In a development, the nozzle is aligned at an angle (different from zero) in relation to a plane perpendicular to the longitudinal axis of the drive shaft. The angle can be between approx. 10° and approx. 50°, for example. Alignment at an angle in relation to the plane perpendicular to the drive shaft is particularly favorable if one of the cutting sets has a rotating cutting head. In this case, the angle is typically selected so that the nozzle is inclined towards the rotating cutting head.

In another development, the nozzle is designed to discharge the fluid in the direction of rotation of the drive shaft (during the comminution of the product). It is favorable if the flow direction of the fluid upon discharge from the nozzle corresponds approximately to the flow direction of the product at the location of the nozzle. In particular, the fluid should have the same direction of rotation (clockwise or counterclockwise) as the drive shaft upon discharge from the nozzle.

In a development of this embodiment, the nozzle is formed in a projection of the housing, which protrudes into the intermediate space, the projection preferably running radially in the direction of the longitudinal axis of the drive shaft. The projection can, for example, be designed in the form of a finger or the like, which runs in a radial direction towards the longitudinal axis of the drive shaft and tapers in the process. The task of such a projection is to jam the product against rotating. The jamming amplifies the conveying behavior of the cutting set and reduces the temperature input. The projections or jamming fingers typically in any case form part of the cutting device, and their geometry makes them particularly suitable for input of the fluid into the product.

In a development, the nozzle is formed on a side of the projection facing away from the direction of rotation of the drive shaft (“lee side”). Such an arrangement of the nozzle has proven to be advantageous for the entrainment of the fluid emerging from the nozzle by the product. This applies, in particular, if one of the cutting sets has a cutting head that is arranged in the intermediate space or projects into it. In this case, a vacuum is created on the rear side of a respective rotating cutting blade of the cutting head, which favors the entrainment of the fluid emerging from the nozzle when the fluid exits on the lee side of the projection.

In a development, the nozzle is arranged at a radial spacing from the longitudinal axis of the drive shaft, which is less than 80%, preferably less than 60%, particularly preferably less than 40% of a maximum radius of the intermediate space in the housing.

The maximum radius of the intermediate space is understood to be the maximum extension of the intermediate space in the radial direction starting from the longitudinal axis of the drive shaft.

It has proven to be favorable if the fluid is introduced into the intermediate space or into the product in a region in which the pressure generated by the rotation of the product is lower than the pressure of the fed fluid when it exits the nozzle due, to the centrifugal force.

Due to components protruding into the intermediate space, or due to the radial extension of the drive shaft, it is generally not possible to arrange the nozzle directly in the vicinity of the longitudinal axis of the drive shaft. However, arranging the nozzle at a spacing of less than 80%, possibly less than 60% or less than 40% of the maximum radius of the intermediate space in the housing is generally possible and usually sufficient to ensure that the pressure generated by the rotation of the product is less than the pressure of the fluid as it exits the nozzle.

The comminuting machine can have at least one nozzle for discharging the fluid into the intermediate space. For a uniform feed of the fluid into the product, it has proven to be favorable if the fluid is fed to the same intermediate space via more than one nozzle, e.g., via two, three, four or more nozzles. For a homogeneous introduction of the fluid into the product, it is favorable if the nozzles are distributed uniformly over the intermediate space in the peripheral direction, i.e., if they are equally spaced from each other in the peripheral direction. It is also generally favorable if the fluid that is fed into the intermediate space exits at the same pressure at each nozzle.

In a further embodiment, the comminuting machine comprises at least one controllable valve for the controlled feed of the fluid into the intermediate space. In the simplest case, the valve has an open and a closed switching state, in order to release or block the fluid (liquid gas) supply. For switching the valve, the comminuting machine has a control device, e.g., in the form of a control computer, which also controls other functions of the comminuting machine. The fluid is usually provided to the controllable valve at a predetermined, constant or controlled pressure with the aid of a fluid feed. The problem with feeding carbon dioxide as the liquid gas is that falling below the pressure leads to snow formation (dry ice) and clogs the feed channel. For this purpose, the fluid is advantageously fed to a respective nozzle with the aid of a separate controllable valve, assigned to the nozzle, via a respective feed channel. In this case, the controllable valve is arranged as close as possible to the respective nozzle, in order to keep the flow channel between the controllable valve and nozzle as short as possible so that the pressure loss in the region between the valve and nozzle is as low as possible. Similarly, the feed channel, which extends inside the housing, should be kept as short as possible in order to minimize the flow pressure loss. The cross-section of the feed channel is usually larger than the discharge cross-section of the discharge opening of the nozzle.

Alternatively, it is also possible for the fluid to be fed to all nozzles assigned to an intermediate space via a common controllable valve, or for the fluid to be fed to all nozzles of the comminuting machine via a single controllable valve. In this case, it is necessary to ensure that the pressure at each nozzle is high enough to reliably prevent the formation of dry ice and thus blockage of the flow channels and nozzles by dry ice.

In other technical applications in which liquid carbon dioxide is sprayed (e.g., tunnel freezers, cabinet freezers, etc.), it is also common practice to pressurize the flow channels, for feeding the fluid, with gaseous fluid before switching on the liquid gas supply, and to flush them with likewise gaseous fluid immediately after switching off the liquid gas supply, in order to empty the pipe system of all liquid gas residues. The gaseous fluid can be the same medium as the liquid gas. This could also be applied here.

The dimensioning, i.e., the calculation of the discharge cross-section of the nozzles, must be carried out depending on the total number of nozzles, the drive power of the machine, the product throughput, the ratios of the liquid gas supply, the required cooling capacity, and the desired product temperature at the end of the comminution process. As described above, the use of one valve per nozzle has proven to be advantageous.

It is favorable to start feeding the fluid, in particular, a liquid gas, only when the product is present in the intermediate space. The presence of the product in the intermediate space can be detected, for example, on the basis of the load absorption of a motor of the drive shaft. The load absorption of the motor can be monitored in order to regulate the product feed, to prevent the cutting heads from running dry on the perforated plates, and to detect faults in the comminuting of the product.

The feed of the fluid to the product during comminution does not necessarily have to be continuous. For example, the feed of the fluid can be controlled depending on the temperature of the product inside the cutting device. In order to measure the temperature of the product, suitable sensors can, for example, be arranged in front of or behind the cutting device in the product flow direction. In the event that sufficient temperature control or cooling of the end product after comminution is detected, the feed of the liquid gas can for example be temporarily stopped, reduced, or interrupted only at individual nozzles from a plurality of nozzles. If the fluid feed is suitably designed, it may also be possible to control or adjust the quantity of fluid fed to the intermediate space per unit of time via an adjustable valve or a suitable throttle.

In a further embodiment, at least one cutting set has a stationary perforated plate which interacts with a rotating cutting head for comminuting the product. It is possible that all cutting sets of the comminuting machine have a stationary perforated plate and a rotating cutting head, but this is not absolutely necessary. The cutting set(s) of the comminuting machine can also be designed in other ways, for example the cutting set can have a stationary perforated plate that interacts with a rotating perforated plate for comminuting the product, or a cutting set based on the rotor-stator principle can be used. The rotor of such a cutting set is typically arranged radially on the inside and is surrounded by the radially outer annular stator. The rotor has knife blades that interact with the cutting gaps of the stator for comminuting the product in the manner of a scissor cut. However, the use of a cutting set having a rotating cutting head has proven to be favorable for the present application, as this creates a vacuum on the rear side of a respective cutting blade or blade wing, which favors the entrainment of the fluid, as described above. The use of a cutting set having a stationary perforated plate has proven to be favorable because the holes in the perforated plate can be used to achieve a very fine distribution of the fluid. In this way, an optimum heat transfer can be achieved.

In a development, a spacing between the cutting head and the stationary perforated plate can be adjusted in the longitudinal direction or along the longitudinal axis of the drive shaft. For adjusting the spacing, the stationary perforated plate and/or the cutting head can be displaced in the axial direction. The stationary perforated plate can be displaced in the axial direction, for example, by displacing an actuator, on which the stationary perforated plate(s) of the cutting set(s) are brought into contact, in the axial direction within a housing, while the shaft comprising the cutting head remains stationary in the axial direction. The actuator can be designed as a sleeve, for example, which is rotatably mounted with an external thread in a corresponding internal thread of the housing. It is also possible to displace the drive shaft along its longitudinal axis in order to adjust the spacing. In this case, the drive shaft is mounted so that it can be displaced in the longitudinal direction. The axial displacement of the shaft can also take place during the rotational movement of the shaft. The distance over which the axial spacing can be varied is usually a few millimeters. By reducing the spacing, for example the cutting blades of the cutting head can be brought into contact with the stationary perforated plate in order to resharpen them if necessary.

It is understood that the comminuting machine has further components that are not described above. For example, an ejector mounted on the drive shaft and driven by it is typically fitted downstream of the cutting sets in the conveying direction of the product. The ejector is used to centrifugally accelerate the product before it is conveyed out of the comminuting machine through an outlet or outlet housing. The conveying of the product can be supported by suction from the outlet side.

A further aspect of the invention relates to a method of the type mentioned at the outset, in which a fluid, in particular, a liquid gas, is fed to at least one intermediate space in the housing, which is formed between two cutting sets that are adjacent along the longitudinal axis of the drive shaft, during the comminution of the product. As described above, the feed of a gas or liquid directly into the product located in the intermediate space can, for example, control the temperature of or inertize the product. It is understood that the fluid can also be fed to the product for another purpose, for example to influence the color, consistency, rheological properties or appearance of the product.

If the fluid is to be used to cool the product, a liquid gas, for example CO₂ or N₂, is preferably fed to the intermediate space for cooling. As described above, in this case the product can be cooled immediately adjacently to the cutting sets where heat is introduced into the product during comminution. Before feeding in liquid gas, it is favorable to first flush the feed channels, serving as cooling channels, with a gaseous medium, in order to remove product residues, mainly water, from these, as water, in particular, can freeze suddenly on contact with the liquid gas and block the respective feed channel. The gaseous medium and the liquid gas can be the same gas, which is taken from a gas reservoir, e.g., a pressurized gas cylinder, at a different pressure in each case, via two different connections.

In one variant of the method, the fluid is fed to the intermediate space only when the presence of the product in the cutting device is detected. The presence of the product in the cutting device can be detected for example on the basis of the power consumption of the drive shaft motor: If this increases or exceeds a predefined limit value, it can be assumed that the product is being comminuted by the cutting device. As described above, it is not absolutely necessary for a fluid to be fed to the product during the entire time that the product is being comminuted in the cutting device.

In a further variant, at least some of the fluid fed to the intermediate space is separated from the product in at least one intermediate space of the cutting device located downstream in the product conveying direction and/or after exiting the comminuting machine. The product to be comminuted typically passes through the cutting device together with the fluid fed into the at least one intermediate space, i.e., the product and the fluid are transported onwards together in the same direction (product conveying direction). The (gaseous) fluid can be separated from the comminuted product after leaving the comminuting machine, for example by feeding the gaseous fluid to a degassing or extraction system (degasser or deaerator), which has a collecting container for demixing the comminuted product and the gaseous fluid. Alternatively, it may also be possible to separate at least some of the gaseous fluid, which is fed to an intermediate space of the cutting device, from the product in (at least) one downstream intermediate space of the cutting device.

In a further variant, a temperature of the comminuted product after it exits the cutting device is controlled by adjusting a feed quantity of the fluid fed to the at least one intermediate space. In this variant, the comminuting machine has at least one temperature sensor or temperature probe, which can be arranged, for example, in an outlet housing or in an outlet pipe of the comminuting machine, in order to measure the temperature of the comminuted product. In this case, the control device of the comminuting machine is designed to adjust the feed quantity of the fluid fed to the at least one intermediate space, in order to regulate the measured actual temperature of the comminuted product to a target temperature.

The amount of fluid fed to the product to be comminuted can be adjusted discontinuously by completely switching on or off individual nozzles or a series of nozzles, but continuous adjustment via one or more of the controllable (control) valves is also possible.

In a further variant, the liquid gas fed to the at least one intermediate space is provided subcooled with respect to its phase equilibrium pressure, in order to prevent gas bubbles. Subcooling of the liquid gas means that the liquid gas is not in a boiling state as is otherwise usual, but is colder than boiling temperature. This prevents gaseous fluid from forming during the fluid flow to the nozzles. This conditioned provision of the fluid or the liquid gas can increase the accuracy of the setting of the product temperature. This can also optionally prevent the formation of snow, which can cause the feed channel to become blocked.

The product that should be cooled during comminution may, for example, be bones that are comminuted for the production of gelatin for pet food or for the production of collagen for cosmetics or pharmaceuticals. The product may also be pork rinds or the like, the temperature of which should generally not exceed approx. 30° C. in order not to negatively affect their color, taste and viscosity (prevention of coagulation of proteins). The product can also be another food product, such as scalded sausage, etc. It is essential in the case of all food products that the shelf life for subsequent storage, and the taste, are not impaired during comminution. By adding a liquid gas, which may, in particular, also be a mixture of multiple liquid gases, the product can be cooled or, if necessary, heated, during comminution, so that this requirement can be met with the aid of the method according to the invention and the comminuting machine according to the invention.

Further advantages of the invention can be found in the description and the drawings. The features set out above and those listed below can also be used individually or together in any combination. The embodiments shown and described are not to be understood as an exhaustive list, but rather have an exemplary character for the description of the invention.

### BRIEF DESCRIPTION OF THE DRAWINGS

In the figures:

FIG. 1 shows a schematic view of an embodiment of a comminuting machine according to the invention in a longitudinal section along a drive shaft;

FIG. 2 shows a schematic view of the comminuting machine of FIG. 1 in a cross-section extending through an intermediate space between two adjacent cutting sets; and

FIG. 3 shows a schematic view of a detail of the comminuting machine of FIG. 1 in a longitudinal section along the drive shaft.

### DETAILED DESCRIPTION OF EMBODIMENTS OF THE INVENTION

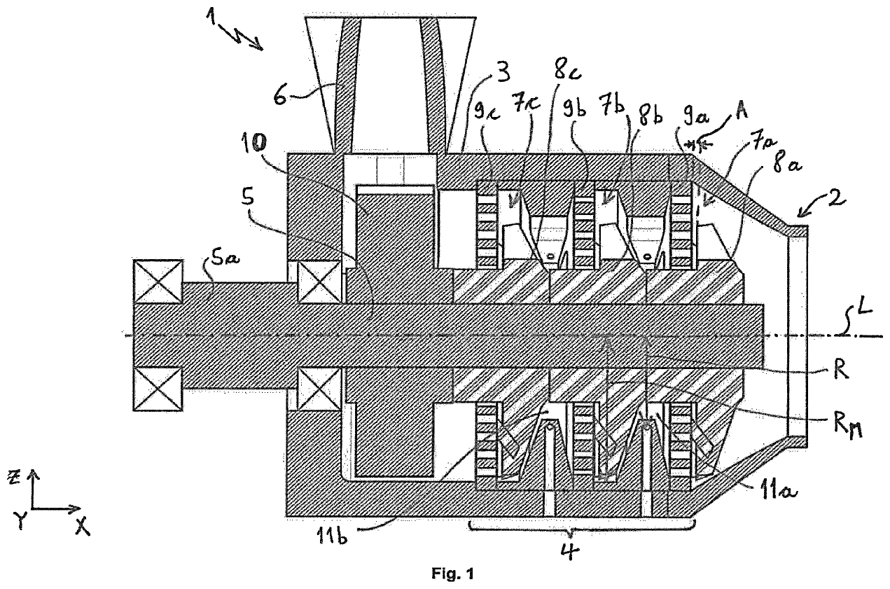

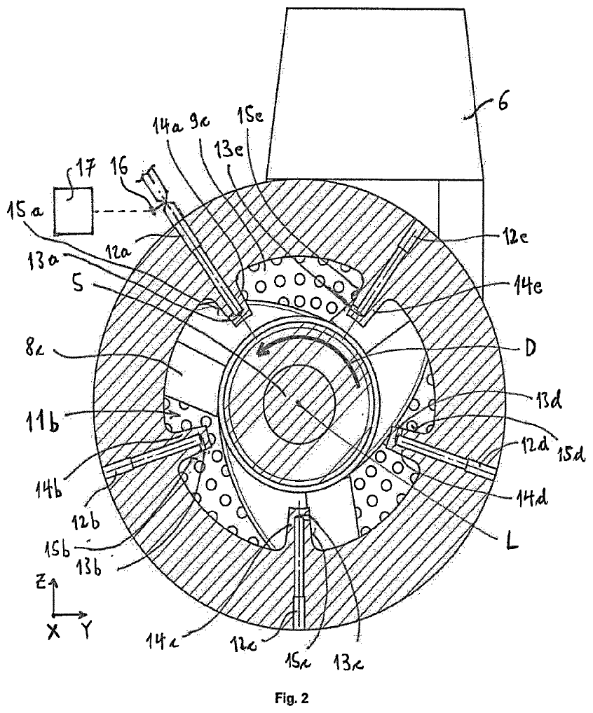

FIG. 1 and FIG. 2 show a comminuting machine 1 which has an inlet housing 2 for feeding a product to be comminuted, for example meat (sausage meat), raw materials of plant or animal origin (fish, vegetables), bones, scalded sausage, pork rinds, etc. A housing 3 adjoins the inlet housing 2, downstream in the conveying direction of the product, in which housing a cutting device 4 is accommodated, which is mounted on a horizontally mounted shaft 5 (drive shaft) driven by a motor 5a. The cutting device 4 is used for (ultra-fine) comminuting of the product. An outlet housing 6 is fitted downstream of the cutting device 4 to discharge the comminuted product. In contrast to what is shown in FIG. 1, the motor 5a can also be attached to the inlet-side end of the drive shaft 5 or to the inlet housing 2.

As can be seen in FIG. 1, starting from the inlet housing 2, a first, second and third cutting set 7a, 7b, 7c are arranged in sequence along a longitudinal axis L of the drive shaft 5. In the example shown, the three cutting sets 7a, 7b, 7c each have a cutting or blade head 8a, 8b, 8c, which, for comminuting the product, interacts in each case with a stationary perforated plate 9a, 9b, 9c fixed in the housing 3. The first, second and third cutting heads 8a, 8b, 8c are non-rotatably mounted on the drive shaft 5 via a positive fit, in the example shown with the aid of grooves made on the drive shaft 5, and are driven by said drive shaft. A respective cutting head 8a, 8b, 8c exerts a centrifugal force on the product so that, in particular, accumulated foreign matter is carried outwards in the radial direction, where they can be discharged via a discharge valve.

The cutting device 4 is completed by an ejector 10, which is mounted on the drive shaft 5. The ejector 10 is used to centrifugally accelerate the comminuted product before it is removed from the comminuting machine 1 via the outlet housing 6.

In the comminuting machine 1 shown in FIG. 1 and FIG. 2, a first intermediate space 11a is formed in the housing 3, between the first and the second cutting set 7a, 7b, and a second intermediate space 11b is formed between the second and the third cutting set 7b, 7c. In the example shown in FIG. 1 and FIG. 2, in which the cutting sets 7a-c each consist of a stationary perforated plate 9a-c and a rotating cutting head 8a-c, the first or second intermediate space 11a, 11b extends along the longitudinal axis L of the drive shaft 5 (X-axis of an XYZ coordinate system) in each case between the two mutually facing sides of the stationary perforated plates 9a, 9b or 9b, 9c. In this case, the second or third cutting head 8b, 8c protrude into the respective intermediate space 11a, 11b.

The comminuting machine 1 is designed to feed a fluid both to the first intermediate space 11a and to the second intermediate space 11b. For this purpose, five feed channels 12a-e for the fluid are formed in the housing 3, which extend from a radially outer side of the housing 3 into the respective intermediate space 11a, 11b, as is shown in FIG. 2 for the second intermediate space 11b. A respective feed channel 12a-e has a portion in the form of a radial bore, extending in the radial direction towards the longitudinal axis L of the drive shaft 5, which is adjoined in relation to the longitudinal axis L of the drive shaft 5 by a portion extending in the tangential direction, also in the form of a bore, which forms a nozzle 13a-e for the essentially tangential discharge of the fluid into the intermediate space 11b. As can also be seen from FIG. 2, a respective nozzle 13a-e is designed or aligned to allow the fluid to exit into the intermediate space 11a in the same direction of rotation D as the drive shaft 5 into the second intermediate space 11b (in the view of FIG. 2 in the direction of rotation of the respective cutting head 8a-c).

As shown in FIG. 2, the nozzle 13a-e, which forms the portion of the feed channel 12a-e extending in the tangential direction, and a radially inner part of the radially extending portion of the feed channel 12a-e are formed in a projection 14a-e of the housing 3, which protrudes into the intermediate space 11b in the radial direction. The projection 14a-e is finger-shaped and tapers in the direction of the longitudinal axis L of the drive shaft 5.

Although the product jams in part at a respective projection 14a-e, the provision of the projections 14a-e on the housing 3 is favorable for the following reason: The fluid should as far as possible be fed to the product at a location at which the pressure or the force of the fluid upon discharge from the respective nozzle 13a-e is greater than the centrifugal force exerted on the product by the cutting head 8c. Since the centrifugal force increases with increasing distance from the longitudinal axis L of the drive shaft 5, the fluid should be fed in close to the longitudinal axis L of the drive shaft 5.

In the example shown in FIG. 1, a respective nozzle 13a-e, or more precisely its discharge opening, is arranged at a radial spacing R from the longitudinal axis L of the drive shaft 5 which is less than 80% of a maximum radius R_{M} of the first or second intermediate space 11a, 11b in the housing 3. The spacing R between the nozzle 13a-e and the longitudinal axis L of the drive shaft can also be less than 60% or possibly less than 40% of the maximum radius R_{M} of the respective intermediate space 11a, 11b.

As can be seen in FIG. 2, the nozzle 13a-e is formed on a side 15a-e of a respective projection 14a-e facing away from the direction of rotation D of the drive shaft 5. In relation to the direction of rotation D of the third cutting head 8c, the respective nozzle 13a-e or its discharge opening is therefore located on the lee side. In this way, when the fluid exits the nozzle 13a-e it is possible to make use of the fact that a reduced pressure is generated on the rear side of a respective cutting blade of the cutting head 8c compared to the front side of the cutting blade, and the fluid is entrained as it exits the nozzle 13a-e.

In order to feed the fluid into the respective intermediate space 11a, 11b, the comminuting machine 1 shown by way of example has five nozzles 13a-e, which are uniformly distributed in the peripheral direction or are arranged at equal spacings from one another in the peripheral direction. In this way, the fluid can be fed homogeneously to the respective intermediate space 11a, 11b. Of course, more or less than five nozzles 13a-e can also be provided in order to feed the fluid to the intermediate space 11a, 11b. Due to the fact that the projections 14a-e, on which the nozzles 13a-e are formed, protrude in a radial direction into the intermediate space 11a, 11b.

FIG. 2 shows a controllable valve 16, which is in signal connection with a control device 17 in order to enable or prevent the feed of fluid to the second intermediate space 11b, depending on the switching state of the valve 16. The fluid is taken from a fluid reservoir, which is not shown in the figure, and fed to the controllable valve 16 via a feed line. In the case of a fluid in the form of a liquid gas, e.g., N₂ or CO₂, which is used to cool the product, the reservoir can be a pressurized gas cylinder, for example. Ideally, the fluid in the form of the liquid gas is provided in the pressurized gas cylinder subcooled relative to its phase equilibrium pressure. In this way, the formation of gas bubbles in the liquid gas and, if necessary, the formation of snow in the feed line can be prevented.

In the example shown in FIG. 2, the controllable valve 16 is used only to control the feed of fluid to the first nozzle 13a. The fluid is fed to the second to fifth nozzle 13b-e via corresponding controllable valves (not shown in the figures). Further controllable valves, not shown in the figures, are used to control the feed of fluid to the nozzles (not shown in FIG. 2), which open into the first intermediate space 11a. Of course, the nozzles 13a-e can also be assigned to the controllable valve(s) 16 in other ways.

It is favorable if the feed of the fluid to the respective intermediate spaces 11a, 11b is only activated when a sufficient quantity of the product is already present in the intermediate spaces 11a, 11b or in the cutting device 4. The presence of the product in the cutting device 4 can be detected, for example, on the basis of the power consumption of the motor 5a of the drive shaft 5: If the power consumption of the motor 5a exceeds a predetermined threshold value, it can be assumed that a sufficient quantity of product is present in the housing 3 and is being comminuted by the cutting device 4, so that a backflow of the fluid into a feeding device for feeding the comminuting machine 1 with the product is prevented or excluded. The fill level of such a feeding device can also be monitored for a sufficient amount of product using suitable sensors. In the event that it is to be assumed that a sufficient quantity of product is present in the housing 3, the control device 17 activates the valve 16 in order to feed the fluid to the intermediate space 11a, 11b.

In the example shown, the control device 17 is also used to regulate the temperature of the comminuted product after it exits the cutting device 4. For this purpose, the comminuting machine 1 has a temperature sensor (not shown in the figures) which, in the example shown, is arranged at a suitable position in the outlet housing 6. The actual temperature of the comminuted product measured by the temperature sensor is transmitted to the control device 17. The control device 17 adjusts the feed amount of the fluid that is fed to the two intermediate spaces 11a, 11b, in order to regulate the temperature of the comminuted product to a target temperature. For this purpose, the control device 17 controls the controllable valves 16 of the comminuting machine 1. For this purpose, the control device 17 can effect a discontinuous adjustment of the feed quantity of the fluid, in that the control device 17 effects a complete switching on or off of individual or a plurality of valves 16. However, the control device 17 can also continuously adjust the feed quantity of the fluid by acting on one or more controllable (control) valves 16, which are designed to continuously adjust the respective feed quantity. In both cases, the temperature of the comminuted product can be regulated to the desired target temperature by adjusting the fluid feed quantity.

It is advantageous if the axial spacing A—shown by way of example for the first cutting set 7a—between the front of the respective stationary perforated plate 9a, 9b, 9c and the cutting head 8a, 8b, 8c, which interacts with it to comminute the product, can be adjusted within certain limits, as this allows the degree of comminution of the product as well as the throughput rate and the heat input into the product to be influenced. It can also be favorable if the respective cutting head 8a, 8b, 8c, or more precisely its knife blades, can be brought into contact with the associated stationary perforated plate 9a, 9b, 9c during the rotary movement, in order to resharpen them if necessary. For the purposes mentioned, a maximum variation of the spacing A of a few millimeters, usually only one or a few tenths of a millimeter, is sufficient.

In order to be able to adjust the spacing A between the respective cutting head 8a, 8b, 8c and the associated perforated plate 9a, 9b, 9c, in the example shown the drive shaft 5 is displaced in the axial direction or along its longitudinal axis L. The axial displacement of the shaft 5 can also be carried out during operation of the comminuting machine 1, for example by means of a handwheel or by means of the control device 17, in order to set the desired spacing A between the respective stationary perforated plate 9a, 9b, 9c and the associated cutting head 8a, 8b, 8c. As an alternative to axial displacement of the shaft 5, the spacing A can also be achieved by displacing the perforated plates 9a, 9b, 9c relative to the housing 3 and to a drive shaft that is stationary in the axial direction, as described, for example, in DE 19960409 A1.

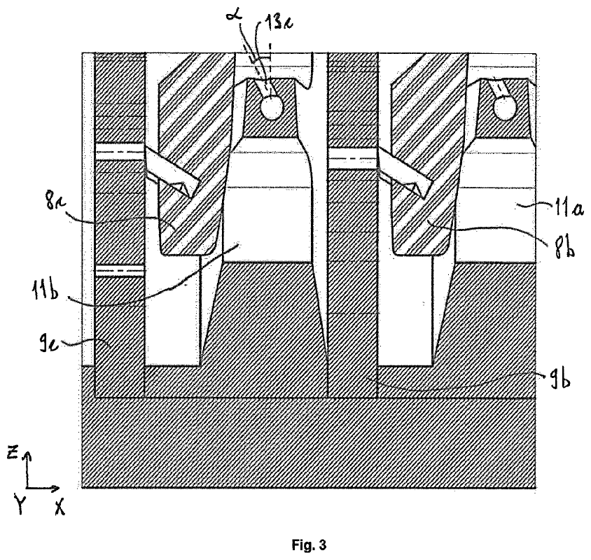

As can be seen in FIG. 3 from the third nozzle 13c, the nozzles 13a-e are aligned at an angle α to the YZ plane, which extends perpendicularly to the longitudinal axis L of the drive shaft 5. The angle α is selected so that the nozzles 13a-e are inclined in the direction of the third cutting head 8c. The angle α can be between 10° and 50°, for example.

More or less than three cutting sets 7a, 7b, 7c can be arranged in the housing 3 for comminuting the product. Of course, in this case the housing 3 should be dimensioned larger or smaller in the axial direction than is the case in FIG. 1.

It is also possible to design the cutting device 4 differently from the cutting device 4 shown in FIG. 1, FIG. 2 and FIG. 3, which only has cutting sets 7a-c in which a stationary perforated plate 9a, 9b, 9c interacts with an associated rotating cutting head 8a, 8b, 8c to produce a scissor cut. For example, the cutting device 4 can have one or more cutting sets in which a stationary perforated plate interacts with a rotating perforated plate for comminuting the product, as described in EP 2 987 557 B1. In the case of such a cutting set, the product is more crushed and squashed rather than cut and therefore appears creamier than is the case during comminution with the aid a cutting set in which a cutting head interacts with a stationary perforated plate, or with a cutting set that has a centrifugal cutting ring (rotor-stator principle). Ideally, the different cutting sets are dimensioned so that they fit into the same (cutting set) housing 3.

Of course, a fluid in the form of a liquid gas does not necessarily have to be fed to the respective intermediate space 11a, 11b to cool the product. Instead of a liquid gas, a gas can also be fed to a respective intermediate space 11a, 11b which can, for example, serve to inertize the product or which can support the conveying effect of the cutting device 4 if the product tends to stick or clump, or a liquid, for example to add a colorant or the like to the product, or steam to heat the product.

In principle, it is possible for the gaseous fluid to remain in the comminuted product. However, it is also possible to separate the comminuted product from the gaseous fluid after it exits the comminuting machine 1. For example, for this purpose, the comminuted product and the gaseous fluid can be fed to a collecting container for demixing, from which the gaseous fluid is extracted.

What is claimed is:

1. A comminuting machine configured for comminuting a product, comprising:
a cutting device configured for comminuting the product, which device has at least two cutting units;
a drive shaft configured for driving the cutting units; and
a housing in which the cutting units are arranged one behind the other along the longitudinal axis of the drive shaft;
wherein the comminuting machine is designed to feed a fluid in the form of a liquid gas into at least one intermediate space which is formed in the housing between two cutting units that are adjacent to one another along the longitudinal axis of the drive shaft.

2. The comminuting machine according to claim 1, including at least one nozzle configured for discharging the fluid into the intermediate space, which nozzle is formed at one end of a feed channel.

3. The comminuting machine according to claim 2, wherein the nozzle is designed for the essentially tangential discharge of the fluid in relation to the longitudinal axis of the drive shaft.

4. The comminuting machine according to claim 2, wherein the nozzle is designed for discharging the fluid in the direction of rotation of the drive shaft.

5. The comminuting machine according to claim 2, wherein the nozzle is formed in a projection of the housing which projects into the intermediate space.

6. The comminuting machine according to claim 5, wherein the nozzle is formed on a side of the projection facing away from the direction of rotation of the drive shaft.

7. The comminuting machine according to claim 2, wherein the nozzle is arranged at a radial distance from the longitudinal axis of the drive shaft which is less than 80% of a maximum radius of the intermediate space in the housing.

8. The comminuting machine according to claim 2, wherein the nozzle is arranged at a radial distance from the longitudinal axis of the drive shaft which is less than 60% of a maximum radius of the intermediate space in the housing.

9. The comminuting machine according to claim 2, wherein the nozzle is arranged at a radial distance from the longitudinal axis of the drive shaft which is less than 40% of a maximum radius of the intermediate space in the housing.

10. The comminuting machine according to claim 2, wherein the nozzle is oriented at an angle with respect to a plane perpendicular to the longitudinal axis of the drive shaft.

11. The comminuting machine according to claim 1, further comprising at least one controllable valve for controlled feed of the fluid into the intermediate space.

12. The comminuting machine according to claim 1, wherein at least one cutting set comprises a stationary perforated plate which cooperates with a rotating cutting head for comminuting the product.

13. The comminuting machine according to claim 12, wherein an axial distance between the cutting head and the stationary perforated plate is adjustable.

14. A method for comminuting the product by means of the comminuting machine according to claim 1, comprising:
comminuting the product in the cutting device of the comminuting machine, the cutting device having the at least two cutting sets which are arranged one behind the other in the housing, along the longitudinal axis of the drive shaft, and are driven by the drive shaft;
wherein during comminution of the product the fluid in the form of the liquid gas is supplied to the at least one intermediate space in the housing, which is formed between the two cutting sets adjacent along the longitudinal axis of the drive shaft.

15. The method according to claim 14, wherein a liquid gas in the form of CO₂ or N₂ is fed to the intermediate space to cool the product.

16. The method according to claim 14, wherein the fluid is fed to the intermediate space only in the event that the presence of the product in the cutting device is detected.

17. The method according to claim 14, wherein at least some of the fluid fed to the intermediate space is separated from the product in at least one intermediate space of the cutting device located downstream in the product conveying direction and/or after leaving the comminuting machine.

18. The method according to claim 14, wherein a temperature of the comminuted product after exiting the cutting device is controlled by adjusting a feed amount of the fluid fed to the at least one intermediate space.

19. The method according to claim 14, wherein the liquid gas fed to the at least one intermediate space is provided subcooled with respect to its phase equilibrium pressure in order to prevent gas bubbles.
